(19) United States
(12) Patent Application Publication
(10) Pub. No.: US 2015/0114158 A1
(43) Pub. Date: Apr. 30, 2015

(54) TRANSMISSION ELECTRONIC SHIFTER WITH DUAL MECHANICAL DETENTS

(71) Applicants: Jay T. TenBrink, Goodrich, MI (US); Robert L. Brown, Clarkston, MI (US); Donald Niskanen, Spring Lake, MI (US); Kirk Ypma, Rockford, MI (US)

(72) Inventors: Jay T. TenBrink, Goodrich, MI (US); Robert L. Brown, Clarkston, MI (US); Donald Niskanen, Spring Lake, MI (US); Kirk Ypma, Rockford, MI (US)

(21) Appl. No.: 14/511,477

(22) Filed: Oct. 10, 2014

Related U.S. Application Data
(60) Provisional application No. 61/895,201, filed on Oct. 24, 2013.

(51) Int. Cl. F16H 59/02; F16H 59/10

(52) U.S. Cl. CPC F16H 59/0278; F16H 59/10; F16H 2059/0282
USPC 74/473.25

(57) ABSTRACT

An electronic shifter assembly can include a shift lever assembly and a dual mechanical detent system. The shift lever assembly can include a shift lever and a pivot base that is pivotably coupled to a base of the electronic shifter assembly. The dual mechanical detent system can include first and second mechanical detent systems having respective first and second detent plungers biased into engagement with respective first and second detent cam members having first and second cam surface profiles. The first and second detent plungers can be coupled to the pivot base and can move relative to the respective first and second cam surface profiles with movement of the shift lever assembly. The first and second mechanical detent systems can each releasably retain the shift lever assembly in a selected one of a plurality of transmission gear selection locations.

### CROSS REFERENCE TO RELATED APPLICATION

This application claims the benefit of U.S. Provisional Ser. No. 61/895,201, filed Oct. 24, 2013.

### FIELD

The present disclosure relates generally to a transmission electronic shifter and, more particularly, to a poly-stable lever style electronic shifter with dual mechanical detents.

### BACKGROUND

More and more vehicles are being equipped with electronic shifters (“e-shifters”) to place the vehicle's automatic transmission into a desired gear state. Electronic shifters can replace the traditional console mounted P-R-N-D-L mechanical shift lever and are typically implemented as levers, which can be pushed up/down or sideways, and/or buttons to effect gear changes. The typical mono-stable lever type electronic shifter returns to its original or home position after it has been manipulated by the driver. A more recent development is to have a multi-position stable or poly-stable e-shifter that retains an actuator setting that represents a driver requested transmission gear state. With the poly-stable e-shifter, the shift lever can retain a manipulated position of the shift lever and, as such, is preferred by many drivers. The shift-by-wire transmissions associated with these mono-stable and poly-stable e-shifters typically do not include a mechanical cable or link to the e-shifter and the associated additional detent member that is incorporated within the mechanically shifted transmission. Accordingly, there is a need for improvement in the relevant art.

### SUMMARY

In one form, an electronic shifter assembly for a shift-by-wire transmission is provided in accordance with the teachings of the present disclosure. The electronic shifter assembly can include a shift lever assembly and a dual mechanical detent system. The shift lever assembly can include a shift lever and a pivot base that is pivotably coupled to a base of the electronic shifter assembly. The dual mechanical detent system can include first and second mechanical detent systems. The first mechanical detent system can have a first detent plunger biased into engagement with a first detent cam member that has a first cam surface profile. The second mechanical detent system can have a second detent plunger biased into engagement with a second detent cam member that has a second cam surface profile. The first and second detent plungers can be coupled to the pivot base and can be configured to move relative to the respective first and second cam surface profiles with movement of the shift lever assembly. The first and second mechanical detent systems can each be configured to releasably retain the shift lever assembly in a selected one of a plurality of transmission gear selection locations.

In another form, an electronic shifter assembly for a shift-by-wire transmission is provided in accordance with the teachings of the present disclosure. The electronic shifter assembly can include a poly-stable shift lever assembly and a dual mechanical detent system. The poly-stable shift lever assembly can include a shift lever and a pivot base pivotably coupled to a base of the electronic shifter assembly. The dual mechanical detent system can be housed within a housing of the base and can include a first mechanical detent system and a second mechanical detent system. The first mechanical detent system can have a first detent plunger biased into engagement with a first detent cam member that has a first cam surface profile. The second mechanical detent system can have a second detent plunger biased into engagement with a second detent cam member that has a second cam surface profile. The first and second detent plungers can be coupled to the pivot base and can be configured to move relative to the respective first and second cam surface profiles with movement of the shift lever assembly. The first and second mechanical detent systems can each be configured to independently releasably retain the shift lever assembly in a selected one of a plurality of transmission gear selection locations.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an exemplary poly-stable electronic shifter assembly associated with an exemplary center console of a vehicle interior according to the principles of the present disclosure;

FIG. 2A is a perspective view of the poly-stable electronic shifter assembly of FIG. 1 with a flexible member removed according to the principles of the present disclosure;

FIG. 2B is a schematic view of an exemplary shift pattern illustrating positions of a shift lever relative to a gate guide according to the principles of the present disclosure;

FIG. 3 is a side view of the poly-stable electronic shifter assembly illustrating the shift lever in various transmission gear selection locations according to the principles of the present disclosure;

FIG. 4 is a partial sectional view of the poly-stable electronic shifter assembly illustrating features of an exemplary dual mechanical detent system according to the principles of the present disclosure;

FIG. 5 is another partial sectional view of the poly-stable electronic shifter assembly illustrating features of the exemplary dual mechanical detent system and the shift lever according to the principles of the present disclosure;

FIG. 6 is a partial side view of the poly-stable electronic shifter assembly with portions of the base housing removed for clarity of illustration of aspects of the dual mechanical detent system according to the principles of the present disclosure;

FIG. 7 is a partial perspective view of the poly-stable electronic shifter assembly with portions of the base removed for clarity of illustration of aspects of the dual mechanical detent system according to the principles of the present disclosure; and

FIG. 8 is a schematic diagram of an exemplary sensor control circuit according to the principles of the present disclosure.

### DESCRIPTION

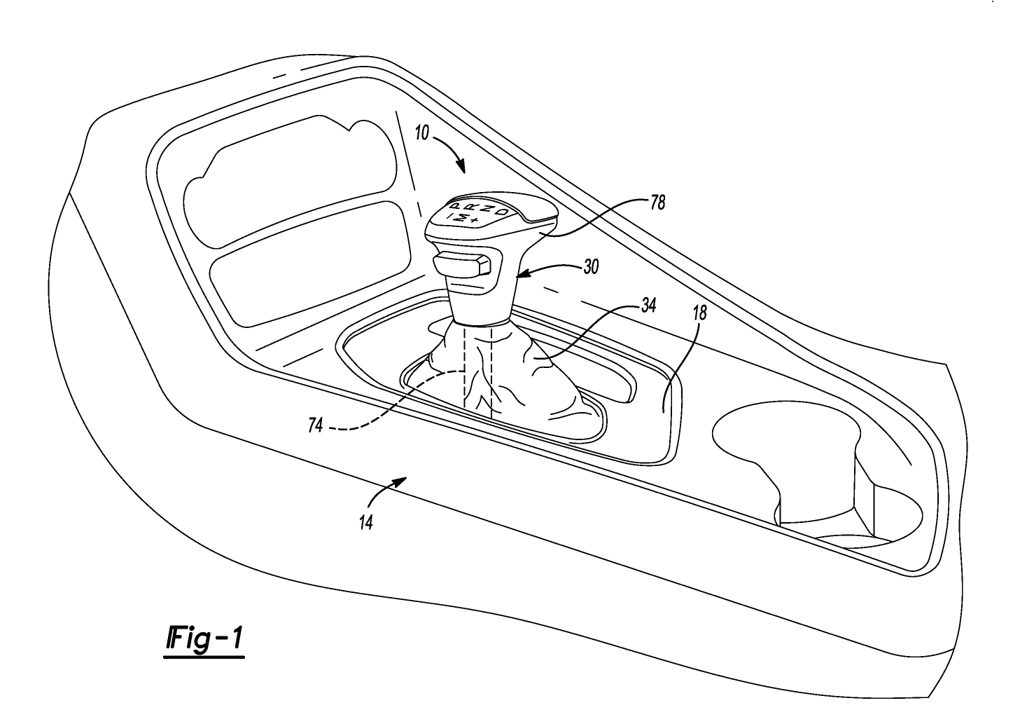

With initial reference to FIG. 1, an exemplary poly-stable electronic shifter assembly is shown and generally identified at reference numeral 10. As shown, the poly-stable electronic shifter assembly 10 can be associated with a center console 14 of an interior of a vehicle. In the exemplary implementation illustrated in FIG. 1, the poly-stable electronic shifter assembly 10 can be surrounded by a trim panel or member 18, such as an interior surface panel. It should be appreciated, however, that the poly-stable electronic shifter assembly 10 could be packaged in the vehicle's interior in various different configurations, including positions other than the center console 14 (e.g., an instrument panel) and with or without trim member 18.

As discussed above, one of the benefits of a poly-stable electronic shifter includes an ability for a shift lever to remain in a position it is placed in by a driver for selecting a transmission gear. Typical transmission gears to be selected are park, reverse, neutral and drive (PRND). As also discussed above, electronic shifters do not include a mechanical cable or link to the transmission, as would be the case for a mechanical shifter associated with a mechanically shifted transmission. The cable and shift systems of the mechanically shifted transmissions can also include a detent system incorporated into the transmission, which can aid (via the cable or link) in retaining the shift lever in its current position and can provide damping to the system.

Accordingly, a poly-stable electronic shifter assembly 10 with a dual mechanical detent system for use with a shift-by-wire automatic transmission is provided in accordance with various aspects of the present disclosure. In one exemplary configuration, the poly-stable electronic shifter assembly 10 can include the dual mechanical detent system housed within the shifter assembly. The dual mechanical detent system can provide redundancy to prevent an undesired shift event to the extent there would be a potential malfunction of one of the dual mechanical detent systems. The dual mechanical detent system can also provide for a more robust shift system with improved tightness and feel to a user, as will be discussed in greater detail below.

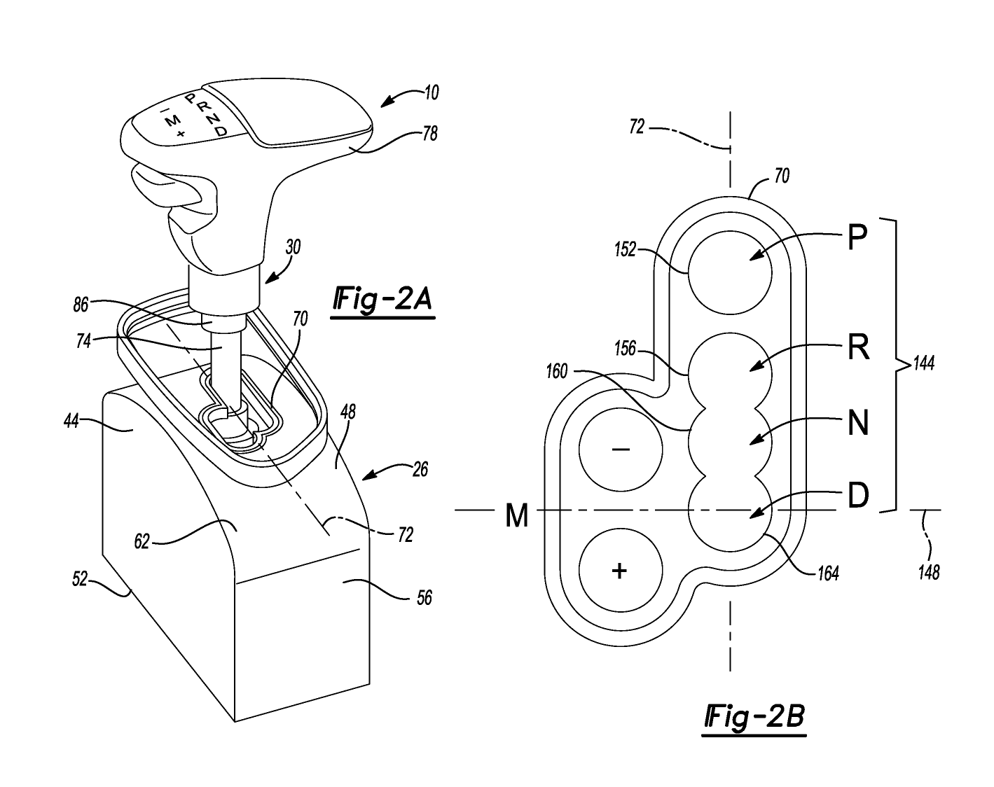

With continuing reference to FIG. 1 and additional reference to FIGS. 2A-4, the poly-stable electronic shifter assembly 10 can include a base 26, a shift lever assembly 30 pivotably coupled to the base 26, a flexible member covering or boot 34, and a dual mechanical detent system 38 housed within base 26. As will be discussed in greater detail below, the dual mechanical detent system 38 can include first and second mechanical detent systems that can releasably retain the shift lever assembly 30 in a desired one of a plurality of transmission gear positions and against an inadvertent or undesired movement to another of the gear positions. The first and second mechanical detent systems can function independently and in unison to provide the above discussed releasable retention and redundancy features. The first and second mechanical detent systems can be tuned to provide a desired tactile feel or feedback to a user and, in one exemplary configuration, can be tuned to provide a feel of a traditional mechanical system.

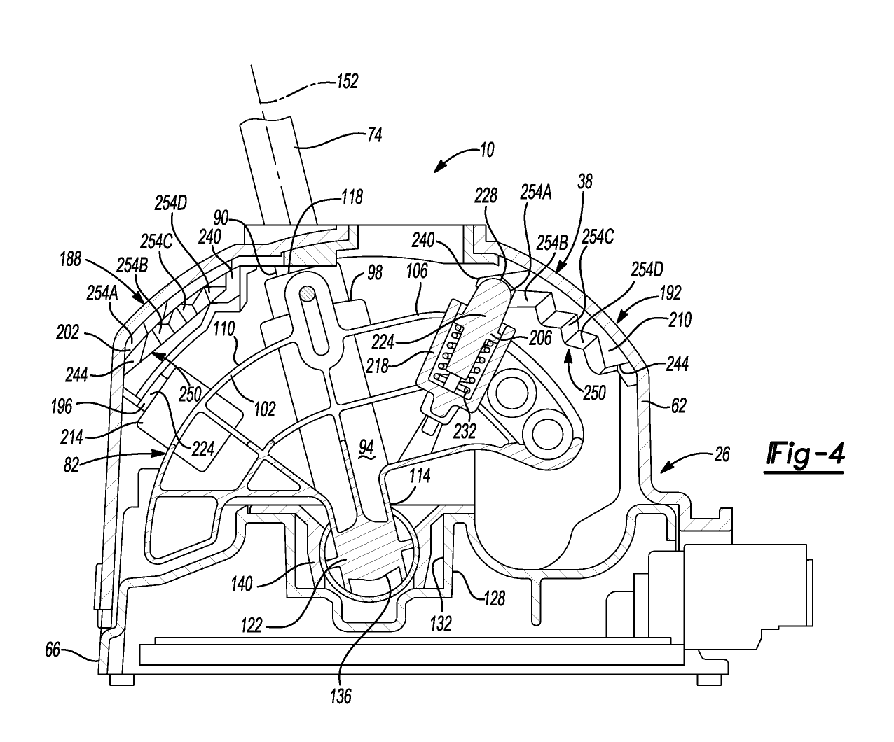

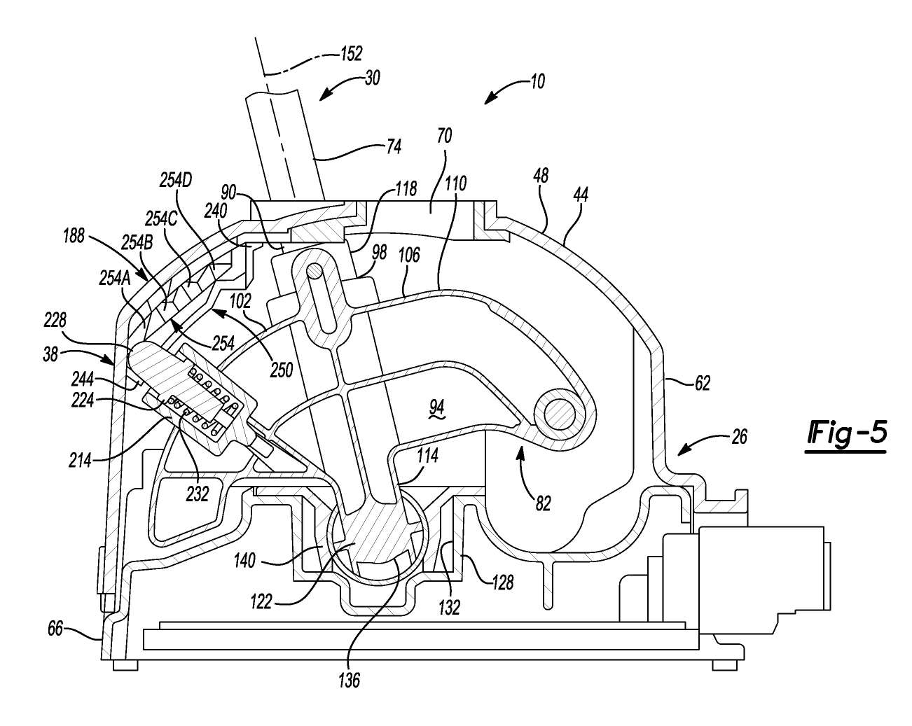

The base 26 can be adapted to be fixedly attached to a vehicle, such as in association with the center console 14 shown in FIG. 1. It should be appreciated, however, that the base 26 along with the components of the poly-stable electronic shifter assembly 10 can be attached or positioned in various interior locations of the vehicle. The base 26 can include an outer housing 44 having an upper end 48, a lower end 52 and a plurality of sides 56. The base 26 can be formed from any suitable materials, such as plastic, and can be provided in a one-piece construction or can be constructed of multiple components secured together. In the exemplary configuration illustrated in the various figures, the base 26 can be formed as a two-piece configuration having an upper housing member 62 and a lower housing member 66, as best shown for example in FIGS. 4 and 5. The upper end 48 of base 26 can include a gate guide 70 configured to guide shift lever assembly 30 along a travel path or axis 72 between and among the PRND gear selection locations.

The shift lever assembly 30 can include a shift lever 74, a shift knob 78 and a shift lever pivot base 82. The shift lever 74 can include a first or upper end 86 coupled to the shift knob 78 and a second or lower end 90 fixed to the shift lever pivot base 82. The shift lever pivot base 82 can include a body 94 defining a central bore 98 and first and second body members 102, 106 extending in opposite directions from central bore 98. In the exemplary configuration illustrated, the first and second body members 102, 106 can extend in directions substantially in-line or substantially parallel to the travel axis 72 of the shift lever assembly 30, which will be discussed in greater detail below.

The body 94 can include an upper end or surface 110 and a lower end or surface 114, as shown for example in FIG. 4. The upper surface 110 can define an opening 118 of central bore 98 and the lower surface 114 can define a coupling member 122. The lower end 90 of shift lever 74 can be received in opening 118 and fixed to central bore 98. The coupling member 122 can cooperate with base 26 to pivotably couple the shift lever assembly 30 thereto. In one exemplary configuration, the base 26 can include a lower body member 128 housed within or integrally formed with lower housing member 66. The lower body member 128 can include or define a coupling area 132 configured to cooperate with the coupling member 122. In an exemplary aspect, the coupling member 122 can be a male coupling member, such as a ball member 136, that is configured to cooperate with coupling area 132, which in this exemplary aspect, can be a female socket 140 sized and shaped to cooperate with ball member 136.

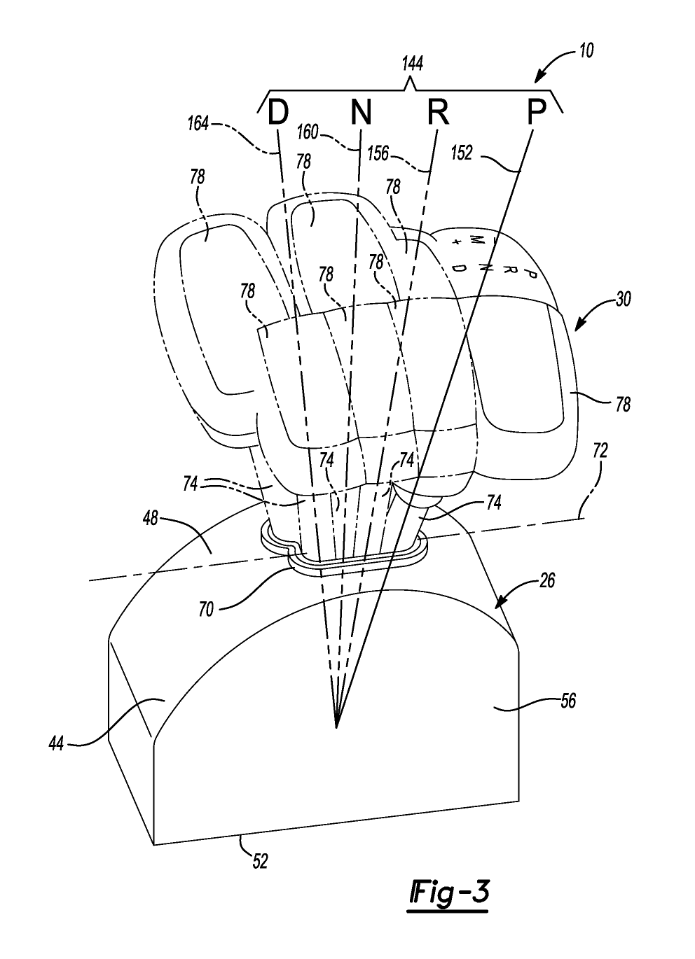

Pivotably coupled in this manner, the shift lever assembly 30 can be pivotable as a unit relative to base 26 and gate guide 70 along travel axis 72 among the PRND gear selection locations 144 (FIG. 3). In other words, pivotal movement of the shift lever 74 correspondingly moves the shift lever pivot base 82 therewith. The shift lever assembly 30 can also be pivotable along a lateral axis 148 perpendicular to, or substantially perpendicular to, travel axis 72 to place the shift lever assembly 30 in a manual-automatic gear selection mode. With particular reference to FIGS. 2B-3, the poly-stable shift lever assembly 30 is shown in the PRND gear selection locations, as well as in manual-automatic positions (e.g., “+” and “−”). For purposes of this discussion, however, the manual-automatic positions will not be discussed in greater detail herein.

The PRND gear selection locations 144 can include a park (P) gear selection location 152, a reverse (R) gear selection location 156, a neutral (N) gear selection location 160, and a drive (D) gear selection location 164, as shown in FIGS. 2B and 3. As can be seen with additional reference to FIG. 8, a rotation or position sensor 170 can be associated with poly-stable electronic shifter assembly 10, such as within housing 44, and can be configured to provide signals representing gear selection locations of shift lever assembly 30 that are utilized in connection with a controller 174, such as a transmission controller, to change the gear of a shift-by-wire automatic transmission 178.

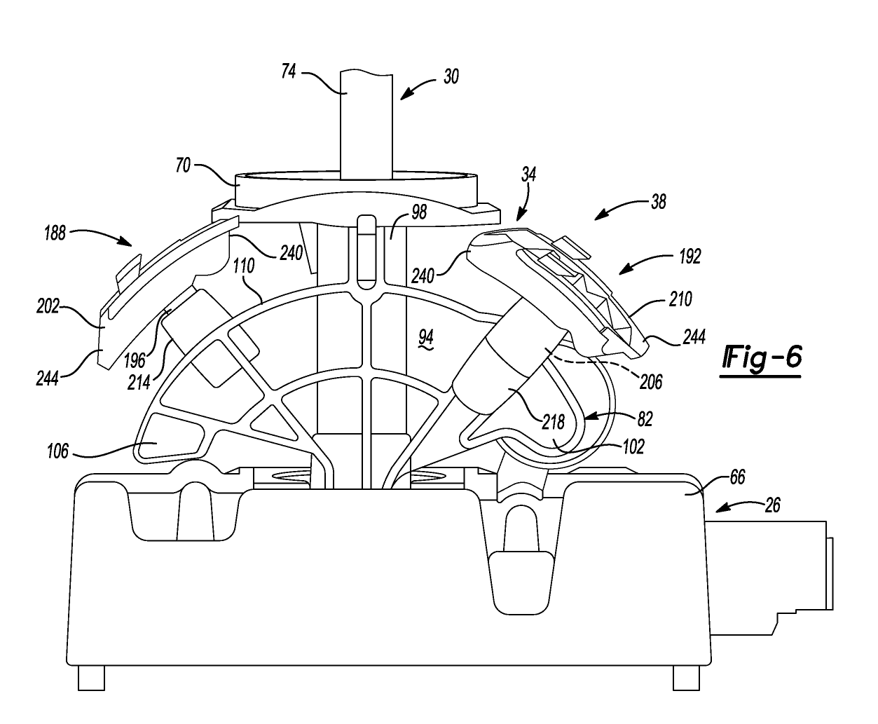

With particular reference to FIGS. 4-7 and continuing reference to FIGS. 1-3, the dual mechanical detent system 38 of the poly-stable electronic shifter assembly 10 will now be discussed in greater detail. The dual mechanical detent system 38 can include first and second mechanical detent systems 188, 192. As discussed above, the first and second mechanical detent systems 188, 192 can not only provide for improved feel and stability of the shifter assembly 10, but can also provide redundant releasable retention of the shift lever assembly 30 in one of the desired RND gear selection locations 144 should one of the first and second mechanical detent systems 188, 192 experience a potential malfunction.

The first mechanical detent system 188 can include a first detent plunger 196 and a first detent cam member 202. Similarly, the second mechanical detent system 192 can include a second detent plunger 206 and a second cam member 210. The first and second detent plungers 196, 206 can be configured to engage and cooperate with the respective first and second cam members 202, 210, as will be discussed in greater detail below.

In the exemplary configuration illustrated in the various figures, the first and second detent plungers 196, 206 can be positioned in first and second bores 214, 218 defined by the respective first and second body members 102, 106 of shift lever pivot base 82. With particular reference to FIGS. 4-7, the first and second bores 214, 218, and thus the first and second detent plungers 196, 206, can be positioned about opposite longitudinal sides of the central bore 98 and each at an acute angle relative thereto. The first and second detent plungers 196, 206 can each include a body 224 having a cam member engaging upper end 228 and an opposed end or area in engagement with a biasing member 232. In the exemplary configuration illustrated, the biasing member 232 can be a spring configured to urge or bias the upper end 228 in a direction away from the ball member 136 (e.g., toward the respective cam members). It should be appreciated, however, that the first and second detent plungers 196, 206 can be provided in various different configurations that include an engagement and biasing function.

The first and second cam members 202, 210 can each be attached to the base 26 such that the shift lever assembly 30 and first and second detent plungers 196, 206 associated therewith move relative to the cam members 202, 210. In the exemplary configuration illustrated in FIGS. 4-7, the first cam member 202 can be positioned adjacent to and spaced apart from the first body member 102. Similarly, the second cam member 210 can be positioned adjacent to and spaced apart from the second body member 106. In this exemplary configuration, the first and second cam members 202, 210 can be spaced apart from each other and positioned about or substantially about opposite longitudinal ends of gate guide 70 such that the shift lever 74 moves or pivots between the first and second cam members 202, 210 along travel axis 72.

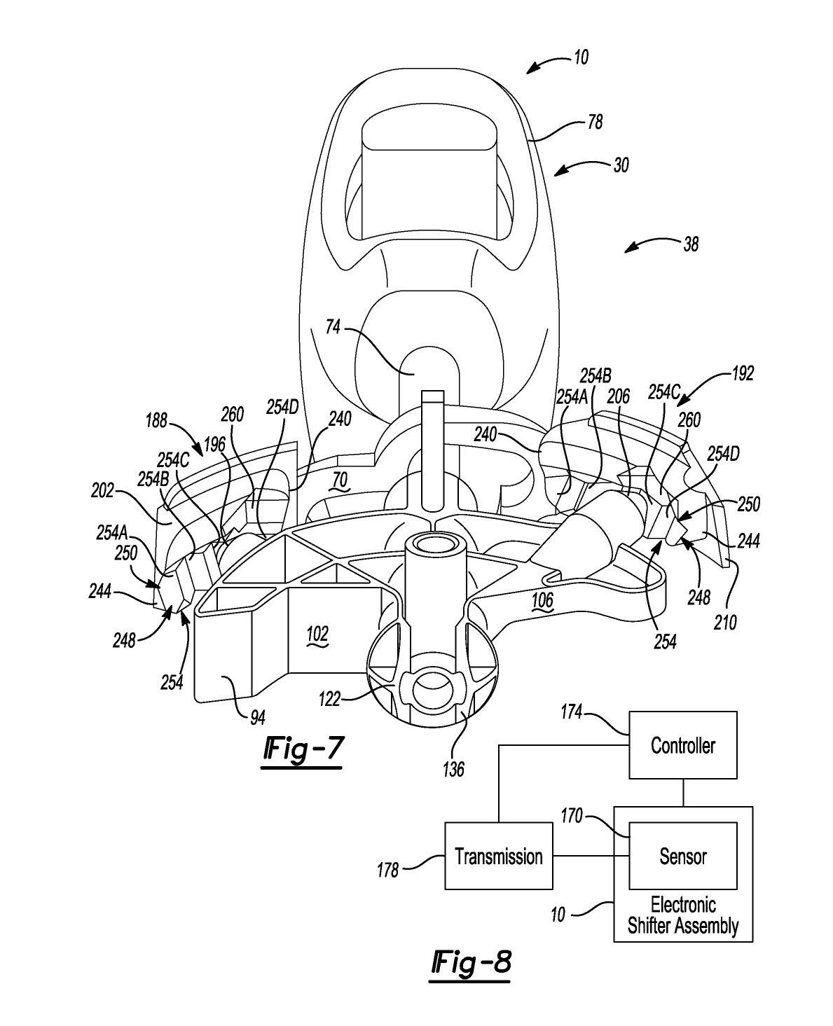

The first and second cam members 202, 210 can each include a first end 240 positioned toward or facing the shift lever 74 and a second opposed end 244. The first and second cam members 202, 210 can define an overall arcuate surface 248 (FIG. 7) between the first and second ends 240, 244. The first and second cam members 202, 210 can each define a cam profile or surface 250 formed by a plurality of grooves or detent positions 254 corresponding to various gear position locations in which the shift lever assembly 30 can be shifted to place the transmission 178 in a desired gear.

For example, each of the cam surfaces 250 can define detent positions 254 corresponding to the PRND gear selection locations 144. In particular, the first cam member 202 can define a park detent position 254A, a reverse detent position 254B, a neutral detent position 254C and a drive detent position 254D starting from the second end 244. The second cam member 210 can define the same positions, but starting from the first end 240, as best shown in FIG. 7. In one exemplary configuration, one or more of the first and second cam members 202, 210 can be laterally offset from the travel axis 72 and/or each other. In the exemplary configuration illustrated in FIGS. 4-7, the second cam member 210 can be laterally offset from the first cam member 202 and the travel axis 72, as shown for example in FIG. 7.

It should be appreciated that the first and second cam members 202, 210 can include a suitable width in the lateral direction so as to have the capability to handle lateral movement of the shift lever assembly 30 and thus corresponding lateral movement of the detent plungers 196, 206. For example, the shift lever assembly 30 may be moved laterally along or parallel to the lateral axis 148 to the manual-automatic gear selection locations. In this example, the cam members 202, 210 can include a cam surface profile having sufficient width to handle such lateral movement of the detent plungers 196, 206, as well as incorporate corresponding detent positions 260, as best shown in FIG. 7.

As briefly discussed above, each of the first and second detent plungers 196, 206 can be biased into engagement with the cam surfaces 250 of the respective first and second cam members 202, 210. In particular, the upper ends 228 can be biased into engagement with the respective cam surfaces 250. As the shift lever assembly 30 is pivoted from the park gear selection location 152 along travel axis 72 to the drive gear selection location 164, the upper end 228 of the first detent plunger 196 can engagingly follow the cam member profile 250 of first cam member 202 from the second end 244 toward the first end 240. During such movement of the shift lever assembly 30, the upper end 228 of the second detent plunger 206 can simultaneously engagingly follow the cam member profile 250 of the second cam member 210 from the first end 240 toward the second end 244.

The detent plungers 196, 206 can be tuned in connection with a size and shape of the detent grooves 254 to provide a desired resistance to movement of the shift lever assembly in a fore/aft direction along travel axis 72 between the various detent grooves 254A-254D corresponding to the PRND gear selection locations 144. In one exemplary implementation, the spring rate of the biasing members 232 associated with the detent plungers 196, 206 can be varied to provide the desired resistance and tactile feedback to the user as to the PRND gear selection locations 144 and movement between such locations. In another exemplary implementation, a depth of the detent grooves 254 can be varied to provide the desired resistance and tactile feedback. In these examples, a larger spring rate and/or a larger detent groove depth can provide greater frictional resistance to movement between one PRND gear selection location and another PRND gear selection location.

In operation, each of the first and second mechanical detent systems 188, 192 can function together as the dual mechanical detent system 38 to releasably maintain a desired gear selection position of the shift lever assembly 30. The first and second mechanical detent systems 188, 192 can each have the capability to independently releasably maintain the desired gear selection position of the shift lever assembly 30 in the event of a potential malfunction with one of the first and second mechanical detent systems 188, 192. Thus, the dual mechanical detent system can provide redundancy to prevent an undesired shift event to the extent there would be a potential malfunction of one of the first and second mechanical detent systems. As discussed above, the dual mechanical detent system can also provide for a more robust shift system with improved tightness and a feel to a user.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An electronic shifter assembly for a shift-by-wire transmission, comprising:
a shift lever assembly including a shift lever and a pivot base pivotably coupled to a base of the electronic shifter assembly; and
a dual mechanical detent system including:
a first mechanical detent system having a first detent plunger biased into engagement with a first detent cam member having a first cam surface profile; and
a second mechanical detent system having a second detent plunger biased into engagement with a second detent cam member having a second cam surface profile;
wherein the first and second detent plungers are coupled to the pivot base and configured to move relative to the respective first and second cam surface profiles with movement of the shift lever assembly;
wherein the first and second mechanical detent systems are each configured to releasably retain the shift lever assembly in a selected one of a plurality of transmission gear selection locations.

2. The electronic shift lever assembly of claim 1, wherein the first and second mechanical detent systems are each independently capable of releasably retaining the shift lever assembly in the selected one of the plurality of transmission gear selection locations.

3. The electronic shifter assembly of claim 1, wherein the shift lever assembly includes a poly-stable shift lever assembly.

4. The electronic shifter assembly of claim 1, wherein the first detent cam member is separate from and spaced apart from the second detent cam member.

5. The electronic shifter assembly of claim 4, wherein a longitudinal axis of the first and second detent cam members is positioned substantially parallel with a travel axis of the shift lever and about opposed sides of the shift lever.

6. The electronic shifter assembly of claim 5, wherein the shift lever is positioned between the first and second detent cam members and is configured to move between the first and second cam members among the plurality of transmission gear selection locations.

7. The electronic shifter assembly of claim 5, wherein one of the first and second detent cam members is laterally offset from the travel axis.

8. The electronic shifter assembly of claim 1, wherein the first and second cam surface profiles of the respective first and second detent cam members each define a plurality of detent positions corresponding to the plurality of transmission gear selection locations.

9. The electronic shifter assembly of claim 8, wherein each of the first and second cam surface profiles define an arcuate surface extending along a longitudinal direction of the first and second detent cam members.

10. The electronic shifter assembly of claim 8, wherein the plurality of transmission gear selection locations include park, reverse, neutral, and drive gear selection locations.

11. The electronic shifter assembly of claim 1, wherein the shift lever is fixed to the pivot base and the first and second detent plungers are slidably coupled to the pivot base about opposed sides of the shift lever.

12. The electronic shifter assembly of claim 11, wherein the first and second detent plungers are positioned along respective first and second longitudinal axes that are each orientated at acute angles relative to a longitudinal axis of the shift lever.

13. The electronic shifter assembly of claim 1, wherein the pivot base includes an upper end defining coupling areas for the first and second detent plungers and an opposed lower end defining a pivot member for pivotably coupling the shift lever assembly to the base.

14. The electronic shifter assembly of claim 13, further comprising a housing associated with the base, wherein the dual mechanical detent system and the pivot base are housed within the housing.

15. An electronic shifter assembly for a shift-by-wire transmission, comprising:
a poly-stable shift lever assembly including a shift lever and a pivot base pivotably coupled to a base of the electronic shifter assembly; and
a dual mechanical detent system housed within a housing of the base, including:
a first mechanical detent system having a first detent plunger biased into engagement with a first detent cam member having a first cam surface profile; and
a second mechanical detent system having a second detent plunger biased into engagement with a second detent cam member having a second cam surface profile;
wherein the first and second detent plungers are coupled to the pivot base and configured to move relative to the respective first and second cam surface profiles with movement of the shift lever assembly;
wherein the first and second mechanical detent systems are each configured to independently releasably retain the shift lever assembly in a selected one of a plurality of transmission gear selection locations.

16. The electronic shifter assembly of claim 15, wherein the first detent cam member is separate from and spaced apart from the second detent cam member; and
wherein the shift lever is positioned between the first and second detent cam members and is configured to move between the first and second cam members among the plurality of transmission gear selection locations.

17. The electronic shifter assembly of claim 15, wherein a longitudinal axis of the first and second detent cam members is positioned substantially parallel with a travel axis of the shift lever and about opposed sides of the shift lever; and
wherein one of the first and second detent cam members is laterally offset from the travel axis.

18. The electronic shifter assembly of claim 15, wherein the shift lever is fixed to the pivot base and the first and second detent plungers are slidably coupled to the pivot base about opposed sides of the shift lever.

19. The electronic shift lever assembly of claim 15, wherein the first and second cam surface profiles of the respective first and second detent cam members each define a plurality of detent positions corresponding to the plurality of transmission gear selection locations.

20. The electronic shift lever assembly of claim 15, wherein the pivot base includes an upper end defining coupling areas for the first and second detent plungers and an opposed lower end defining a pivot member for pivotably coupling the shift lever assembly to the base.
